(19) United States
(12) Patent Application Publication
(10) Pub. No.: US 2015/0205170 A1
(43) Pub. Date: Jul. 23, 2015

(54) LIQUID CRYSTAL DISPLAY

(71) Applicant: Sharp Kabushiki Kaisha, Osaka-shi, Osaka (JP)

(72) Inventors: Kohhei Tanaka, Osaka-shi (JP); Hidefumi Yoshida, Osaka-shi (JP); Kazutoshi Kida, Osaka-shi (JP); Yuhji Yashiro, Osaka-shi (JP); Yasuhiro Sugita, Osaka-shi (JP); Hiroyuki Ogawa, Osaka-shi (JP)

(21) Appl. No.: 14/419,525

(22) PCT Filed: Aug. 7, 2013
(86) PCT No.: PCT/JP2013/071330

§ 371 Date: Feb. 4, 2015

(30) Foreign Application Priority Data
Aug. 9, 2012 (JP) 2012-177579

(51) Int. Cl. G02F 1/1343; G06F 3/044; G02F 1/1333

(52) U.S. Cl. CPC G02F 1/134309; G02F 1/13338; G06F 3/044

(57) ABSTRACT

A liquid crystal display device equipped with in-cell touch panel functionality is configured to increase location determining performance by reducing a driving load on sensor electrodes (location determining electrodes). A liquid crystal display device 1 equipped with touch panel functionality includes: drive electrodes 13; detection electrodes 12; drive electrode-specific auxiliary wires 13a; and detection electrode-specific auxiliary wires 12a, the drive electrode-specific auxiliary wires 13a and the detection electrode-specific auxiliary wires 12a being provided so as to overlap domain boundaries 6b.

### TECHNICAL FIELD

The present invention relates to a liquid crystal display device equipped with in-cell touch panel functionality.

### BACKGROUND ART

Conventionally, display devices equipped with touch panels have been put to widespread use. In recent years, display devices equipped with in-cell touch panels (touch panels embedded in display panels) have been introduced (hereinafter, such a display device will also be referred to simply as “display device”) for the purpose of reducing thickness and weight, improving viewability, reducing the number of components for costs reduction, and the like (see, for example, Patent Literature 1).

FIG. 15 is a cross-sectional view schematically illustrating a configuration of a display device disclosed in Patent Literature 1. FIG. 16 is a plan view illustrating a configuration of sensor electrodes taken along the line A-B illustrated in FIG. 15.

As illustrated in FIG. 15, a display device 300 disclosed in Patent Literature 1 includes a display panel 304 in which a liquid crystal layer 303 is sandwiched between a TFT substrate 301 and a CF substrate 302.

A CF layer 318, which includes light shielding parts 316 (BM) and a plurality of colored layers 317 (CF) provided between adjacent light shielding parts 316, is provided between an insulating substrate 311 and a counter electrode 319 (common electrode) which are included in the CF substrate 302. Between the CF layer 318 and the insulating substrate 311, first electrode layers 312 and second electrode layers 314 are provided to as sensor electrodes (location determining electrodes). Between the first electrode layers 312 and the second electrode layers 314, an insulating layer 313 is provided.

As illustrated in FIGS. 15 and 16, the first electrode layers 312 each have (i) linear line parts 312a extending in a first direction and (ii) bulging parts 312b each bulging out from a line part 312a. The second electrode layers 314 each have (i) linear line parts 314a extending in a second direction orthogonal to the first direction and (ii) bulging parts 314b each bulging our from a line part 314a.

According to the display device 300, a touch location of a finger or a pen for an input operation (detection target) is determined by detecting a change in capacitance when the detection target touches a display screen (capacitive method). This allows a touch location to be determined with a simple configuration.

### CITATION LIST

### Patent Literature

Patent Literature 1
Japanese Patent Application Publication, Tokukai, No. 2010-72581 (Publication Date: Apr. 2, 2010)

### SUMMARY OF INVENTION

### Technical Problem

According to the display device 300, (i) the second electrode layers 314 and the counter electrode 319 are in close proximity to each other and (ii) the counter electrode 319 is provided as one solid electrode all over the display panel. This causes a large amount of parasitic capacitance to be formed between the second electrode layers 314 and the counter electrode 319, and therefore causes a driving load of the sensor electrodes to be large. Hence, it is not possible to obtain a sufficient S/N ratio (signal-to-noise ratio), and therefore a problem of reduction in detection performance occurs.

The present invention has been made in view of the problem, and it is an object of the present invention to configure a liquid crystal display device equipped with in-cell touch panel functionality to increase location determining performance by reducing a driving load on sensor electrodes (location determining electrodes).

### Solution to Problem

In order to attain the object, a liquid crystal display device of the present invention is a liquid crystal display device equipped with touch panel functionality in which specified coordinates of a detection target are determined by a change in capacitance, said liquid crystal display device including: an active matrix substrate; a counter substrate; an liquid crystal layer sandwiched between the active matrix substrate and the counter substrate; pixel electrodes and a counter electrode configured to cause a voltage to be applied across the liquid crystal layer; drive electrodes and detection electrodes configured to determine the specified coordinates; drive electrode-specific auxiliary wires electrically connected to the drive electrodes; and detection electrode-specific auxiliary wires electrically connected to the detection electrodes, a plurality of domains being formed in each of pixels, and the drive electrode-specific auxiliary wires and/or the detection electrode-specific auxiliary wires being provided so as to overlap boundaries of the plurality of domains when the liquid crystal display device is viewed two-dimensionally.

With the configuration, it is possible to reduce, by providing the drive electrode-specific auxiliary wires and the detection electrode-specific auxiliary wires, wire resistance of the detection electrodes and the drive electrodes which serve as sensor electrodes (location determining electrodes). This allows for a reduction in driving load of the sensor electrodes, and therefore restricts a reduction in S/N ratio. Therefore, it is possible to increase location determining performance of a touch panel in comparison with the conventional configuration (see FIG. 15). In addition, since the drive electrode-specific auxiliary wires and the detection electrode-specific auxiliary wires are provided so as to overlap the dark lines that occur on domain boundaries, there is no risk to causing a reduction in transmissivity.

The liquid crystal display device is preferably configured such that the drive electrode-specific auxiliary wires and the detection electrode-specific auxiliary wires are narrower in line width than dark lines that occur on the boundaries of the plurality of domains.

The liquid crystal display device can be configured such that: the drive electrode-specific auxiliary wires and the detection electrode-specific auxiliary wires are provided so as to be orthogonal to each other when the liquid crystal display device is viewed two-dimensionally; and either one of the drive electrode-specific auxiliary wires and the detection electrode-specific auxiliary wires is provided at regular intervals for every N (N is an integer that is not less than 1 and not more than the number of colors of which a color filter is made up) pixels whereas the other one of the drive electrode-specific auxiliary wires and the detection electrode-specific auxiliary wires is provided at regular intervals for every pixel.

The liquid crystal display device is preferably configured such that the pixel electrodes and/or the counter electrode are/is provided with slits configured to control alignment of liquid crystal molecules of the liquid crystal layer.

Hence, it is possible to easily realize a multi-domain configuration.

The liquid crystal display device can be configured such that the slits are arranged in a radial pattern extending from a center part of each of the pixels toward end parts of said each of the pixels.

The liquid crystal display device can be configured such that the slits are arranged in at least two differing directions.

The liquid crystal display device can be configured such that the pixel electrodes and the counter electrode (i) are each formed in a comb-like form and (ii) each include a plurality of comb-like electrodes; and the plurality of comb-like electrodes of the pixel electrodes and the plurality of comb-like electrodes of the counter electrode mesh with each other.

### Advantageous Effects of Invention

The liquid crystal display device of the present invention is thus configured such that the counter electrode is provided with slits for controlling alignment of liquid crystal molecules of the liquid crystal layer. This allows a liquid crystal display device equipped with in-cell touch panel functionality to increase location determining performance by reducing a driving load on sensor electrodes (location determining electrodes).

### BRIEF DESCRIPTION OF DRAWINGS

FIG. 1 is a cross-sectional view schematically illustrating a configuration of a liquid crystal display device in accordance with an embodiment (Example 1) of the present invention.

FIG. 2 is a plan view illustrating part of the liquid crystal panel in accordance with Example 1.

FIG. 3 is a plan view illustrating a wide area of the liquid crystal panel in accordance with Example 1.

FIG. 4 is a set plan views (a) through (c) illustrating a touch panel of a capacitive method, (a) of FIG. 4 being a plan view for describing a configuration of electrodes of the touch panel, (b) of FIG. 4 being a cross-sectional view taken along the line A-B illustrated in (a) of FIG. 4, and (c) of FIG. 4 being a view for describing how the touch panel operates when a finger touches the touch panel.

FIG. 5 is a cross-sectional view taken along the line C-D illustrated in FIG. 2.

FIG. 6 is a plan view illustrating part of a liquid crystal panel in accordance with Example 2.

FIG. 7 is a cross-sectional view taken along the line A-B illustrated in FIG. 6.

FIG. 8 is a cross-sectional view taken along the line C-D illustrated in FIG. 6.

FIG. 9 is a plan view illustrating part of a liquid crystal panel in accordance with Example 3.

FIG. 10 is a cross-sectional view taken along the line A-B illustrated in FIG. 9.

FIG. 11 is a plan view illustrating part of a liquid crystal panel in accordance with Example 4.

FIG. 12 is a cross-sectional view taken along the line A-B illustrated in FIG. 11.

FIG. 13 is a plan view illustrating part of a liquid crystal panel in accordance with Example 5.

FIG. 14 is a cross-sectional view taken along the line A-B illustrated in FIG. 13.

FIG. 15 is a cross-sectional view schematically illustrating a configuration of a display device disclosed in Patent Literature 1.

FIG. 16 is a plan view illustrating a configuration of sensor electrodes as taken cross-sectionally along the line A-B illustrated in FIG. 15.

### DESCRIPTION OF EMBODIMENTS

The following description will discuss an embodiment of a liquid crystal display device of the present invention, which is equipped with in-cell touch panel functionality (hereinafter referred to simply as “liquid crystal display device”).

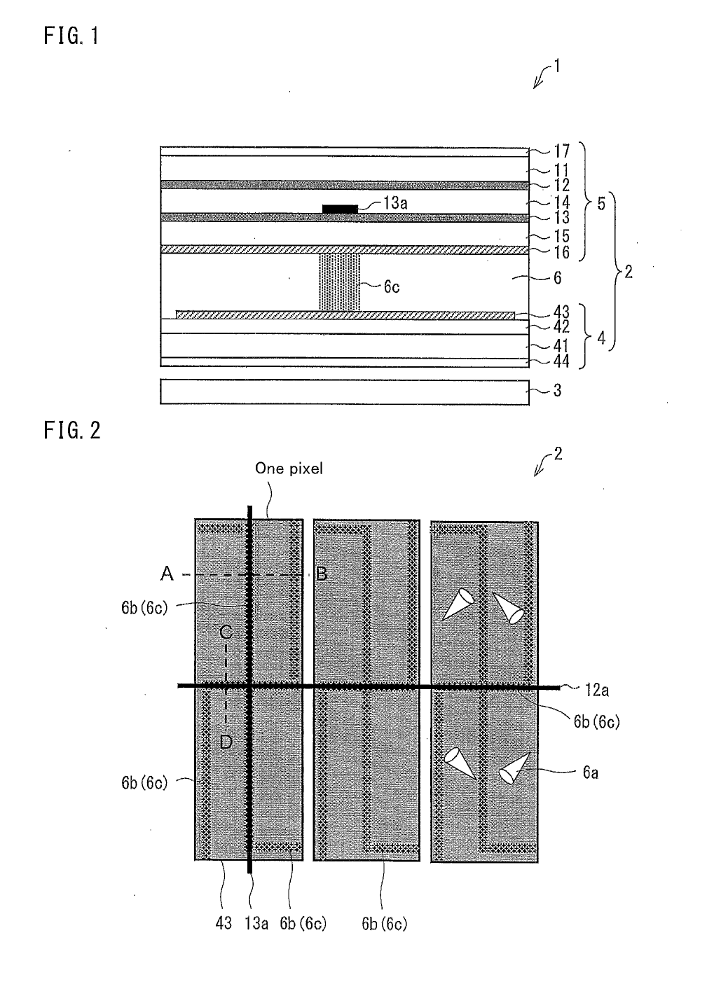

FIG. 1 a cross-sectional view schematically illustrating a configuration of a liquid crystal display device in accordance with the present embodiment. A liquid crystal display device 1 illustrated in FIG. 1 includes (i) a liquid crystal panel 2 equipped with normal image display functionality and with touch panel functionality by use of the capacitive method, (ii) various drive circuits (data signal line drive circuit, scan signal line drive circuit, and the like; not illustrated) for driving the liquid crystal panel 2, and (iii) a backlight 3 for illuminating the liquid crystal panel 2.

The liquid crystal panel 2 is an active matrix display panel in which a liquid crystal layer 6 is sandwiched between a pair of substrates (an active matrix substrate 4 (TFT substrate) and a counter substrate 5 (color filter (CF) substrate)). According to the liquid crystal panel 2, (i) the counter substrate 5 faces an observer (detection target) and (ii) the backlight 3 is provided to face a back surface of the active matrix substrate 4.

The active matrix substrate 4 includes a glass substrate 41, and includes, on the glass substrate 41, (i) various signal lines such as scan signal lines and data signal lines (not illustrated), (ii) transistors (TFTs) (not illustrated), (iii) an insulating film 42, (iv) pixel electrodes 43 corresponding to respective pixels provided in a matrix, and (v) a polarizing plate 44. The active matrix substrate 4 can have a well-known configuration.

The counter substrate 5 has a configuration for realizing image display functionality and a configuration for realizing touch panel functionality. An example of a specific configuration of the liquid crystal display device will be discussed below.

### EXAMPLE 1

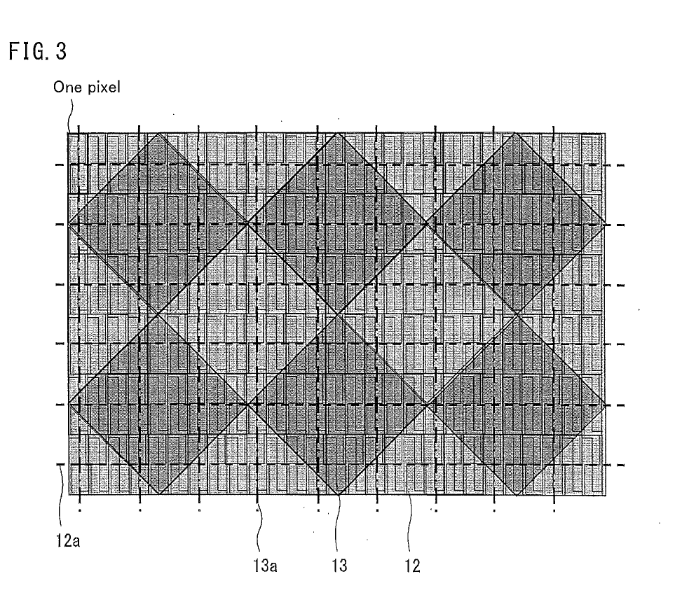

A liquid crystal display device in accordance with Example 1 is configured as illustrated in FIG. 1. FIG. 2 is a plan view illustrating part of a liquid crystal panel 2 of Example 1. FIG. 1 is a cross-sectional view taken along the line A-B illustrated in FIG. 2. FIG. 3 illustrates a wide area of the liquid crystal panel 2 of Example 1. FIG. 2 illustrates a part corresponding to three pixels. Note, however, that a pixel structure is not limited to such a configuration, but can be configured such that a single pixel is made up of three sub-pixels (R sub-pixel, G sub-pixel, and B sub-pixel) and that FIG. 2 is assumed to illustrate such a single pixel. Alternatively, each pixel can include a plurality of pixel electrodes to have a pixel-partitioned structure.

The counter substrate 5 includes (i) a glass substrate 11, (ii) a plurality of detection electrodes 12 and a plurality of drive electrodes 13 serving as location determining electrodes (sensor electrodes), (iii) detection electrode-specific auxiliary wires 12a, (iv) drive electrode-specific auxiliary wires 13a, (v) a first insulating film 14, (vi) a second insulating film 15, (vii) a black matrix (not illustrated), (viii) a color filter layer (not illustrated), (ix) a counter electrode 16, and (x) a polarizing plate 17.

When the liquid crystal panel 2 is viewed two-dimensionally as illustrated in FIG. 3, (i) the detection electrodes 12 (parts shown in light gray color) are arranged in a row direction and a column direction, (ii) the drive electrodes 13 (parts shown in dark gray color) are arranged in the row direction and the column direction, and (iii) the detection electrodes 12 and the drive electrodes 13 are alternated in diagonal directions. For convenience, FIG. 1 does not illustrate such patterning of the detection electrodes 12 and the drive electrodes 13.

The detection electrodes 12 and the drive electrodes 13 are transparent, and are each made of, for example, a transparent conductive material such as an oxide. Examples of the transparent conductive material encompass ITO (indium tin oxide), IZO (indium zinc oxide), zinc oxide, and tin oxide. Alternatively, the detection electrodes 12 and the drive electrodes 13 can each be transparent as a result of being a thin electrode. Examples of the thin electrode encompass (i) a metal thin-film electrode such as graphene and (ii) a thin-film carbon electrode.

FIG. 1 illustrates the detection electrodes 12 and the drive electrodes 13 as two independent layers. Note, however, that the detection electrodes 12 and the drive electrodes 13 are not limited to such a configuration, but can be a single layer. In such a case, either detection electrodes 12 or drive electrodes 13 are connected to one another by bridge connection. Alternatively, how the detection electrodes 12 are arranged and how the drive electrodes 13 are arranged can be interchanged.

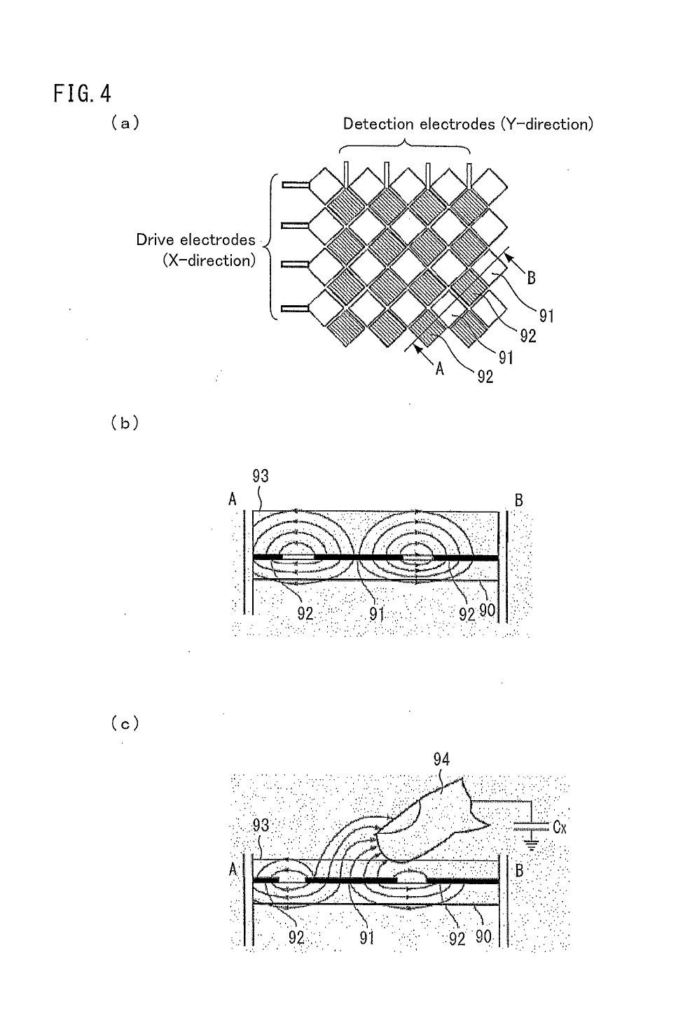

The detection electrodes 12 and the drive electrodes 13 allow the capacitive-method touch panel functionality to be realized. An operating principle of a capacitive method-based touch panel will be described below with reference to FIG. 4.

FIG. 4 schematically illustrates a capacitive method-based touch panel. (a) of FIG. 4 is a plan view for describing a configuration of electrodes of the touch panel. (b) of FIG. 4 is a cross-sectional view taken along the line A-B illustrated in (a) of FIG. 4. (c) of FIG. 4 is a cross-sectional view for describing how the touch panel operates when a finer (detection target) touches the touch panel. Note that FIG. 4 illustrates a configuration in which detection electrodes and drive electrodes are provided in a single layer.

In FIG. 4, the reference sign, 90, indicates a substrate made of a transparent insulator (dielectric). On one surface of the substrate 90, a plurality of drive electrodes 91 and a plurality of detection electrodes 92 are provided. A cover glass 93 is provided so as to cover the surface on which the drive electrodes 91 and the detection electrodes 92 are provided. The cover glass 93 is made of an insulator, such as transparent glass, which has predetermined dielectric constant.

In (a) of FIG. 4, drive electrodes 91 of respective columns are connected to one another in an X-axis direction, and detection electrodes 92 of respective rows are connected to one another in a Y-axis direction. Either the drive electrodes 91 or the detection electrodes 92 are connected to one another by bridge connection. In a case where a drive voltage is applied across the drive electrodes 91 and the detection electrodes 92, a capacitance is formed between the drive electrodes 91 and the detection electrodes 92 via the substrate 90 and the cover glass 93, so that lines of electric force as illustrated in (b) of FIG. 4 are formed.

In so doing, when a fingertip 94 touches a front surface of the cover glass 93 as illustrated in (c) of FIG. 4, a capacitance Cx is formed between the touch panel and the ground via a human body, so that part of the lines of electric force is grounded via the fingertip 94. This indicates that a capacitance between part of the drive electrodes 91 and part of the detection electrodes 92, which parts correspond to a location touched by the fingertip 94, is changed by a large amount. By determining such an amount of the change, the location touched by the fingertip 94 can be determined.

A capacitive-based location determining method is not limited to the above method, but can be a well-known method. That is, it is possible to employ a mutual capacitive method-based touch panel or a self-capacitive method-based touch panel.

Note that the liquid crystal panel 2 is of a multi-domain RTN mode in which optical alignment process or the like provides tilt angles to liquid crystal molecules 6a in the vicinity of the pixel electrodes 43 and the counter electrode 16 so that a plurality of domains are formed. In the example shown in FIG. 2, application of a voltage causes the liquid crystal molecules 6a to be aligned in a spiral pattern, so that four domains are formed in each pixel. In the present example, domain boundaries 6b each having a swastika shape are formed. Note that the liquid crystal panel 2 can employ different liquid crystal modes such as 4-domain mode, 2-domain mode, or mono-domain mode.

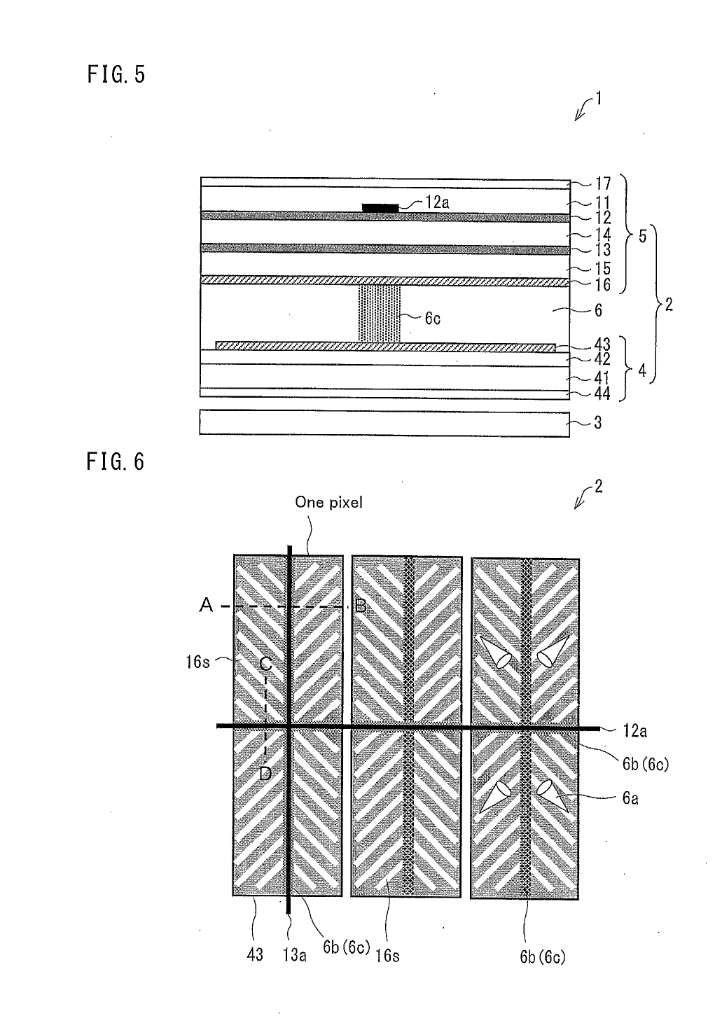

The detection electrodes-specified auxiliary wires 12a are electrically connected to detection electrodes 12 while the drive electrodes-specified auxiliary wires 13a are electrically connected to drive electrodes 12. FIG. 5 illustrates a cross section taken along the line C-D illustrated in FIG. 2.

When the liquid crystal panel 2 is viewed two-dimensionally, the detection electrodes-specified auxiliary wires 12a and the drive electrodes-specified auxiliary wires 13a are provided so as to overlap dark lines 6c that occur at domain boundaries 6b (see FIGS. 1 and 5). The detection electrode-specific auxiliary wires 12a and the drive electrode-specific auxiliary wires 13a are narrower in line width (breadth) than the dark lines 6c. This makes it possible to reduce, while restricting a reduction in transmissivity, wire resistance of the detection electrodes 12 and the drive electrodes 13.

Although FIG. 2 shows the auxiliary wires 12a and 13a arranged to form a cross shape, the auxiliary wires can be provided on any dark lines (e.g. end parts of a pixel).

As illustrated FIGS. 2 and 3, each of the drive electrodes-specified auxiliary wires 13a is provided for every three pixels (as provided in, for example, a B pixel of the three pixels) However, the present invention is not limited to such a configuration. In fact, each of the drive electrode-specific auxiliary wires 13a can be provided for every pixel or every two pixels. In a case where (i) each pixel is made up of three colors, red (R), green (G), and blue (B) and (ii) each of the drive electrode-specific auxiliary wires 13a is provided for every pixel, the drive electrode-specific auxiliary wires 13a are preferably provided to correspond to R pixels, G pixels, and B pixels respectively. Alternatively, the detection electrode-specific auxiliary wires 12a and the drive electrode-specific auxiliary wires 13a can be arranged in the column direction and the row direction, respectively.

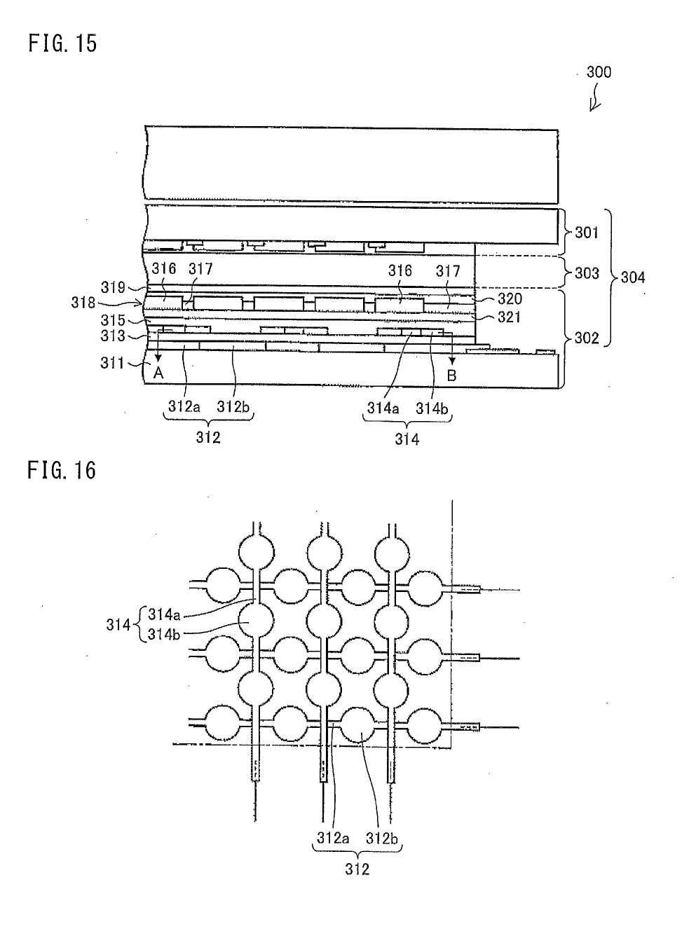

Since the auxiliary wires 12a and 13a are thus provided, it is possible to reduce wire resistance of the detection electrodes 12 and the drive electrodes 13. This allows for a reduction in a driving load on sensor electrodes (the detection electrodes 12 and the drive electrodes 13), and therefore restricts a reduction in S/N ratio. Therefore, it is possible to increase location determining performance of a touch panel in comparison with the conventional configuration (see FIG. 15). Furthermore, since the auxiliary wires 12a and 13a are provided so as to overlap the dark lines 6c that occur at the domain boundaries 6b, there is no risk of a decrease in transmissivity.

### EXAMPLE 2

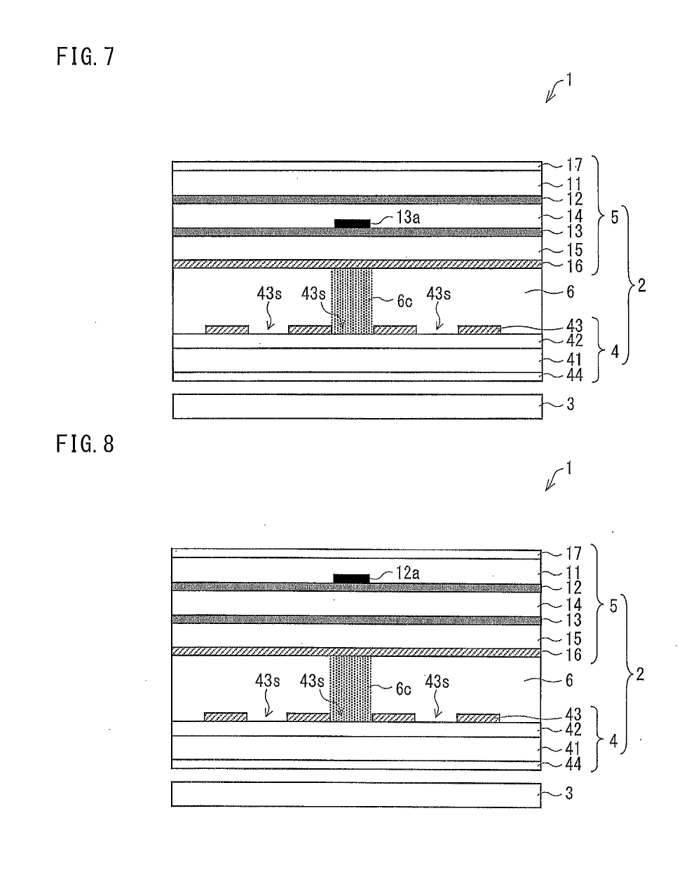

FIG. 6 is a plan view illustrating part of a liquid crystal panel 2 of a liquid crystal display device 1 in accordance with Example 2. FIG. 7 is a cross-sectional view taken along the line A-B illustrated in FIG. 6. FIG. 8 is a cross-sectional view taken along the line C-D illustrated in FIG. 6.

According to the liquid crystal panel 2 of Example 2, pixel electrodes 43 are each provided with a plurality of slits 43s for controlling alignment of liquid crystal molecules 6a of a liquid crystal layer 6 (see FIG. 6). Specifically, when viewed two-dimensionally, the slits 43s are formed in a radial pattern extending from a center part of each pixel to end parts of the pixel. The domain boundaries 6b are formed in a cross shape passing through center parts of the pixels and extending in a row direction and a column direction. The rest of the configuration of the liquid crystal panel 2 is identical to the configuration of the liquid crystal display device 1 of Example 1.

According to the configuration of Example 2, an alignment direction is controlled by the slits 43s which are provided in four differing directions. This, when a voltage is applied, causes the liquid crystal molecules 6a to be aligned in a radial pattern, so that four domains are formed in each of the pixels. Therefore, the liquid crystal display device 1 of Example 2 produces an advantageous effect identical to that produced by the liquid crystal display device 1 of Example 1.

### EXAMPLE 3

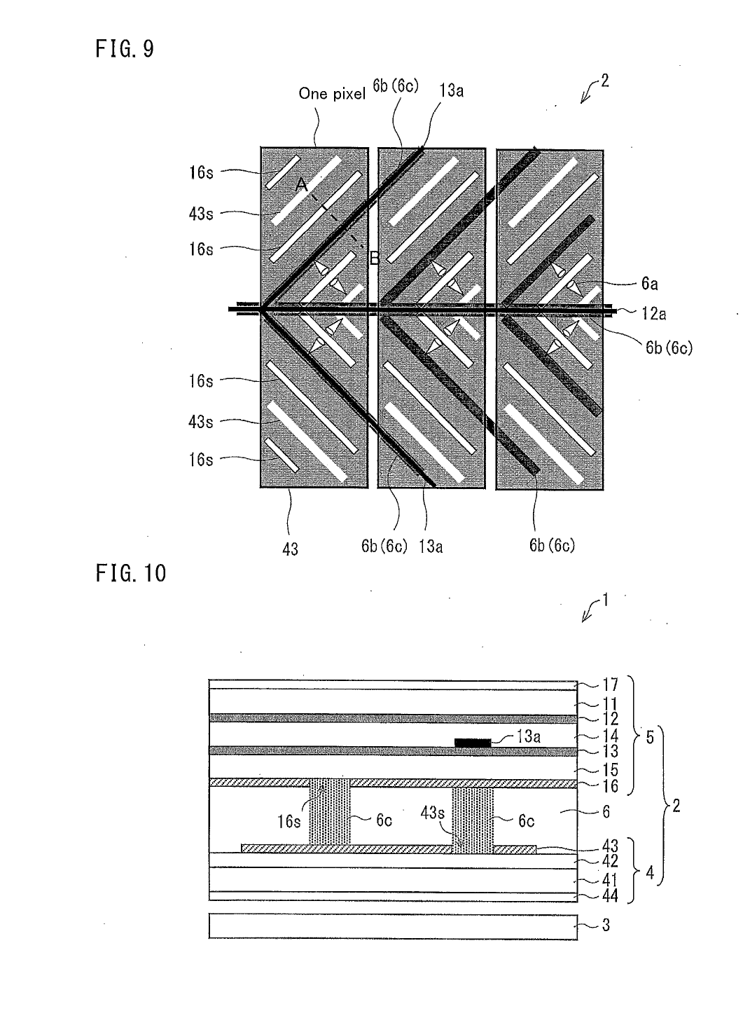

FIG. 9 is a plan view illustrating part of a liquid crystal panel 2 of a liquid crystal display device 1 in accordance with Example 3. FIG. 10 is a cross-sectional view taken along the line A-B illustrated in FIG. 9.

According to the liquid crystal panel 2 of Example 3, as illustrated in FIGS. 9 and 10, (i) pixel electrodes 43 are each provided with a plurality of slits 43s for alignment control and (ii) a counter electrode 16 is provided with a plurality of slits 16s for alignment control. When viewed two-dimensionally, the slits 43s and 16s are formed in a V-shape. Specifically, the slits 43s and 16s are formed so as to (i) have symmetry in a vertical (columnar) direction with respect to a center line extending in a row direction across a center part of a pixel, (ii) extend diagonally in an upper right direction in an upper-half region of the pixel, and (iii) extend diagonally in a lower right direction in a lower-half region of the pixel. The slits 16s are thus formed to extend in two differing directions. This causes an oblique electric field to occur between the pixel electrodes 43 and the counter electrode 16, and therefore causes a plurality of domains to be formed (PVA mode).

The detection electrode-specific auxiliary wires 12a are formed so as to overlap dark lines 6c that occur on respective domain boundaries 6b formed linearly in the row direction. The drive electrode-specific auxiliary wires 13a are formed so as to overlap dark lines 6c that occur on domain boundaries 6b formed in a V-shape. Therefore, the liquid crystal display device 1 of Example 3 produces an advantageous effect similar to that produced by the liquid crystal display device 1 of Example 1.

Note that although FIG. 10 illustrates the configuration in which the slits 16s are provided on the counter electrode 16, it is possible to provide protruding structures (ribs) on the counter electrode 16 (MVA mode) as an example of another configuration.

### EXAMPLE 4

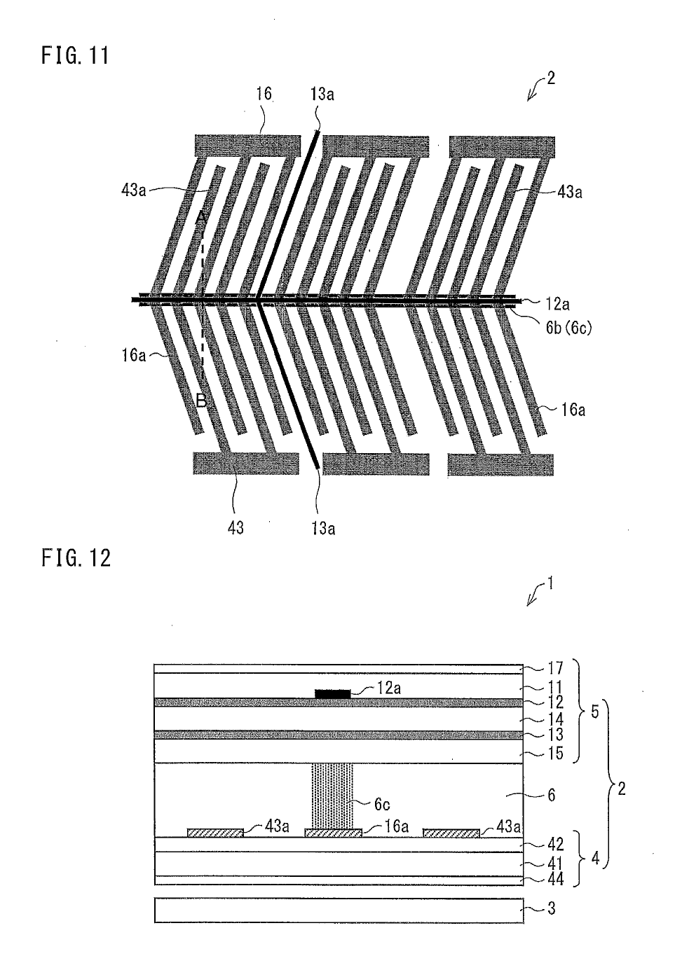

FIG. 11 is a plan view illustrating part of a liquid crystal panel 2 of a liquid crystal display device 1 in accordance with Example 4. FIG. 12 is a cross-sectional view taken along the line A-B illustrated in FIG. 11.

According to the liquid crystal panel 2 of Example 4, as illustrated in FIGS. 11 and 12, pixel electrodes 43 and a counter electrode 16 are both formed in a comb-like form on an active matrix substrate 4. The pixel electrodes 43 and the counter electrode 16 include, in a row direction, a plurality of comb-like electrodes 43a and 16a, respectively. The comb-like electrodes 43a and 16a are formed in a V-shape. As illustrated in FIG. 11, the pixel electrodes 43 and the counter electrode 16 are provided so that the comb-like electrodes 43a and 16a mesh with each other. In other words, the comb-like electrodes 16a of the counter electrode 16 are each provided so as to be located between comb-like electrodes 43a (which are adjacent to each other in the row direction) of the pixel electrodes 43. This causes a horizontal electric field to occur between the pixel electrodes 43 and the counter electrode 16, and therefore causes a plurality of domains to be formed (IPS mode).

Detection electrode-specific auxiliary wires 12a are provided so as to overlap dark lines 6c that occur on domain boundaries 6b formed linearly in the row direction. Therefore, the liquid crystal display device 1 of Example 4 produces an advantageous effect similar to that produced by the liquid crystal display device 1 of Example 1.

Note that the liquid crystal panel 2 of Example 4 employing the IPS mode does not require the counter electrode 16 on a counter substrate 5. Therefore, according to FIG. 12, the counter electrode 16 is not provided on the counter substrate 5. However, it is possible to provide a shielding layer between a liquid crystal layer 6 and drive electrodes 13 in order to (i) reduce noise which enters through the liquid crystal layer 6, the drive electrodes 13, and the like and/or (ii) prevent electric charge, which would cause disorderly alignment, from entering from outside the liquid crystal panel 2 into the liquid crystal layer 6.

Note also that since the number of domains is normally two in an IPS mode, there occurs only one dark line 6c on one domain boundary 6b. Therefore, FIG. 11 illustrates a configuration in which a detection electrode-specific auxiliary wire 12a overlaps a dark line 6c on a domain boundary 6b. Meanwhile, drive electrode-specific auxiliary wires 13a can be provided in non-display regions such as (i) regions located between adjacent pixels (see FIG. 11), (ii) regions overlapping source bus line, and/or (iii) regions overlapping a black matrix.

### EXAMPLE 5

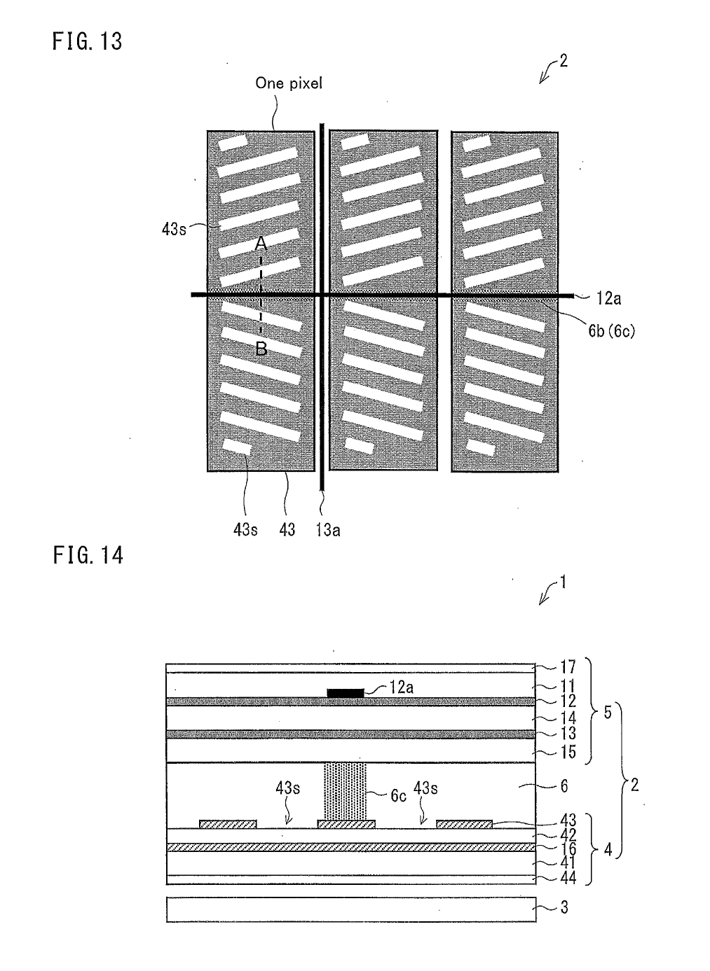

FIG. 13 is a plan view illustrating part of a liquid crystal panel 2 of a liquid crystal display device 1 in accordance with Example 5. FIG. 14 is a cross-sectional view taken along the line A-B illustrated in FIG. 13.

According to the liquid crystal panel 2 of Example 5, slits 43s are provided in a V-shape on pixel electrodes 43 as illustrated in FIGS. 13 and 14. Specifically, the slits 43s are formed so as to (i) have symmetry in a vertical (columnar) direction with respect to a center line extending in a row direction across a center part of a pixel, (ii) extend diagonally in an upper right direction in an upper-half region of the pixel, and (iii) extend diagonally in a lower right direction in a lower-half region of the pixel. The slits 43s are thus formed to extend in two differing directions. The liquid crystal panel 2 of Example 5 constitutes a liquid crystal panel of an FFS mode.

As is the case of an IPS mode, an FFS mode also realizes a multi-domain configuration by designing the slits 43s of the pixel electrodes 43 to be angled by several degrees. In so doing, auxiliary wires 12a and 13a are provided so as to overlap dark lines 6c that occur on domain boundaries 6b which differ in angle from each other. Therefore, the liquid crystal display device 1 of Example 5 produces an advantageous effect similar to that produced by the liquid crystal display device 1 of Example 1.

Note that according to the liquid crystal panel 2 of Example 5 employing an FFS mode, a counter electrode 16 is provided on an active matrix substrate 4. Therefore, as is the case of an IPS mode, there is no need to provide the counter electrode 16 on a counter substrate 5. Therefore, according to FIG. 14, the counter electrode 16 is not provided. However, it is possible to provide a shielding layer between a liquid crystal layer 6 and drive electrodes 13 in order to (i) reduce noise which enters through the liquid crystal layer 6, the drive electrodes 13, and the like and/or (ii) prevent electric charge, which would cause disorderly alignment, from entering from outside the liquid crystal panel 2 into the liquid crystal layer 6.

Note also that since the number of domains is normally two in an FFS mode as with an IPS mode, there occurs only one dark line 6c on one domain boundary 6b. Therefore, FIG. 13 illustrates a configuration in which a detection electrode-specific auxiliary wire 12a overlaps a dark line 6c on a domain boundary 6b. Meanwhile, drive electrode-specific auxiliary wires 13a can be provided in non-display regions such as (i) regions located between adjacent pixels (see FIG. 13), (ii) regions overlapping source bus line, and/or (iii) regions overlapping a black matrix.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### INDUSTRIAL APPLICABILITY

A liquid crystal display device of the present invention equipped with touch panel functionality is suitable for various mobile devices, large displays, and the like.

### REFERENCE SIGNS LIST

1 Liquid crystal display device

2 Liquid crystal panel

3 Backlight

4 Active matrix substrate

5 Counter substrate

6 Liquid crystal layer

6a Liquid crystal molecule

6b Domain boundary

6c Dark line

11 Glass substrate

12 Detection electrode (location determining electrode)

12a Detection electrode-specific auxiliary wire

13 Drive electrode (location determining electrode)

13a Drive electrode-specific auxiliary wire

14 First insulating film

15 Second insulating film

16 Counter electrode

16a Comb-like electrode

16s Slit

17 Polarizing plate

41 Glass substrate

42 Insulating film

43 Pixel electrode

43a Comb-like electrode

43s Slit

44 Polarizing plate

1. A liquid crystal display device equipped with touch panel functionality in which specified coordinates of a detection target are determined by a change in capacitance,
said liquid crystal display device comprising:
an active matrix substrate;
a counter substrate;
an liquid crystal layer sandwiched between the active matrix substrate and the counter substrate;
pixel electrodes and a counter electrode configured to cause a voltage to be applied across the liquid crystal layer;
drive electrodes and detection electrodes configured to determine the specified coordinates;
drive electrode-specific auxiliary wires electrically connected to the drive electrodes; and
detection electrode-specific auxiliary wires electrically connected to the detection electrodes,
a plurality of domains being formed in each of pixels, and
the drive electrode-specific auxiliary wires and/or the detection electrode-specific auxiliary wires being provided so as to overlap boundaries of the plurality of domains when the liquid crystal display device is viewed two-dimensionally.

2. The liquid crystal display device as set forth in claim 1, wherein
the drive electrode-specific auxiliary wires and the detection electrode-specific auxiliary wires are narrower in line width than dark lines that occur on the boundaries of the plurality of domains.

3. The liquid crystal display device as set forth in claim 1, wherein:
the drive electrode-specific auxiliary wires and the detection electrode-specific auxiliary wires are provided so as to be orthogonal to each other when the liquid crystal display device is viewed two-dimensionally; and
either one of the drive electrode-specific auxiliary wires and the detection electrode-specific auxiliary wires is provided at regular intervals for every N (N is an integer that is not less than 1 and not more than the number of colors of which a color filter is made up) pixels whereas the other one of the drive electrode-specific auxiliary wires and the detection electrode-specific auxiliary wires is provided at regular intervals for every pixel.

4. The liquid crystal display device as set forth in claim 1, wherein
the pixel electrodes and/or the counter electrode are/is provided with slits configured to control alignment of liquid crystal molecules of the liquid crystal layer.

5. The liquid crystal display device as set forth in claim 4, wherein
the slits are arranged in a radial pattern extending from a center part of each of the pixels toward end parts of said each of the pixels.

6. The liquid crystal display device as set forth in claim 4, wherein
the slits are arranged in at least two differing directions.

7. The liquid crystal display device as set forth in claim 1, wherein:
the pixel electrodes and the counter electrode (i) are each formed in a comb-like form and (ii) each include a plurality of comb-like electrodes; and
the plurality of comb-like electrodes of the pixel electrodes and the plurality of comb-like electrodes of the counter electrode mesh with each other.
